(19) United States
(12) Patent Application Publication
(10) Pub. No.: US 2016/0065923 A1
(43) Pub. Date: Mar. 3, 2016

(54) ELECTRONIC DEVICE AND COLOR GAMUT DETERMINATION METHOD

(71) Applicants: KABUSHIKI KAISHA TOSHIBA, Tokyo (JP); Toshiba Lifestyle Products & Services Corporation, Tokyo (JP)

(72) Inventor: Takayuki ARAI, Hamura Tokyo (JP)

(21) Appl. No.: 14/686,586

(22) Filed: Apr. 14, 2015

(30) Foreign Application Priority Data
Aug. 29, 2014 (JP) 2014-176490

(51) Int. Cl. H04N 9/64; G09G 5/06; G06T 7/40; G09G 5/02

(52) U.S. Cl. CPC H04N 9/64; G09G 5/02; G09G 5/06; G09G 5/026; G06T 7/408; G09G 2320/0666; G09G 2340/06; G09G 2320/0673

(57) ABSTRACT

According to one embodiment, an electronic device 100 comprises a first color gamut converter configured to convert each pixel of input video data into RGB data, a first nonstandard determination module configured to determine whether the RGB data converted by the first color gamut converter is outside a first color gamut or not, a first counter configured to count number of pixels of which RGB data converted by the first color gamut converter is outside the first color gamut per unit time of the video data, and a first color gamut determination module configured to determine, based on the number of pixels counted by the first counter, whether a color gamut of the input video data is the first color gamut or a color gamut wider than the first color gamut.

### CROSS-REFERENCE TO RELATED APPLICATIONS

This application is based upon and claims the benefit of priority from Japanese Patent Application No. 2014-176490, filed Aug. 29, 2014, the entire contents of which are incorporated herein by reference.

### FIELD

Embodiments described herein relate generally to an electronic device and a color gamut determination method for determining a color gamut of an input video signal.

### BACKGROUND

In 2012, the International Telecommunication Union (ITU) recommended ITU-R BT.2020 (hereinafter referred to as BT.2020) as a video signal standard. Under BT.2020 it is possible to transmit a video signal including information of a wider color gamut than is possible under BT.709, which is a terrestrial digital television broadcasting signal standard, or DCI-P3, which is a digital cinema signal standard.

It should be noted that video signals having the full dynamic range of BT.2020 cannot be used until cameras, editing equipment, monitors, wide-color-gamut display panels, etc., compatible with a wide color gamut become widespread. Accordingly, video signals having the dynamic range of a narrow color gamut such as BT.709 or DCI-P3 are often input to wide-color-gamut display panels.

Even on a wide-color-gamut display panel, however, if a video signal having the dynamic range of a narrow color gamut is displayed as a video signal having the dynamic range of a wide color gamut, the signal does not produce a vivid picture. Therefore, in an electronic device using a wide-color-gamut display panel, the color gamut of an input video signal must be determined, subjected to suitable image processing based on the result of the determination, and output.

In view of the above circumstances, the embodiments aim to provide an electronic device and a color gamut determination method for determining a color gamut of the input video signal to contribute to suitable image processing.

An electronic device of one of the embodiments comprises: a first color gamut converter configured to convert each pixel of input video data into RGB data; a first nonstandard determination module configured to determine whether the RGB data converted by the first color gamut converter is outside a first color gamut or not; a first counter configured to count number of pixels of which RGB data converted by the first color gamut converter is outside the first color gamut per unit time of the video data; and a first color gamut determination module which determines, based on the number of pixels counted by the first counter, whether a color gamut of the input video data is the first color gamut or a color gamut wider than the first color gamut.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing a configuration example of an electronic device 100 to which an embodiment is applied.

FIG. 2 is a graph showing the width of a color gamut of each of BT.2020, DCI-P3 and BT.709 by CIE xy chromaticity.

FIG. 3 is a block diagram of the flow of signal processing in a video data processor.

FIG. 4 is a flowchart showing operations of color gamut determination processing of the video data processor.

FIG. 5 is an exemplary block diagram of a flow of signal processing in a video data processor of a second embodiment.

FIG. 6 is another exemplary block diagram of a flow of signal processing in the video data processor of the second embodiment.

### DETAILED DESCRIPTION

Various embodiments will be described hereinafter with reference to the accompanying drawings.

In general, according to one embodiment, an electronic device comprising a first color gamut converter configured to convert each pixel of input video data into RGB data; a first nonstandard determination module configured to determine whether the RGB data converted by the first color gamut converter is outside a first color gamut or not; a first counter configured to count number of pixels of which RGB data converted by the first color gamut converter is outside the first color gamut per unit time of the video data; and a first color gamut determination module configured to determine, based on the number of pixels counted by the first counter, whether a color gamut of the input video data is the first color gamut or a color gamut wider than the first color gamut.

### First Embodiment

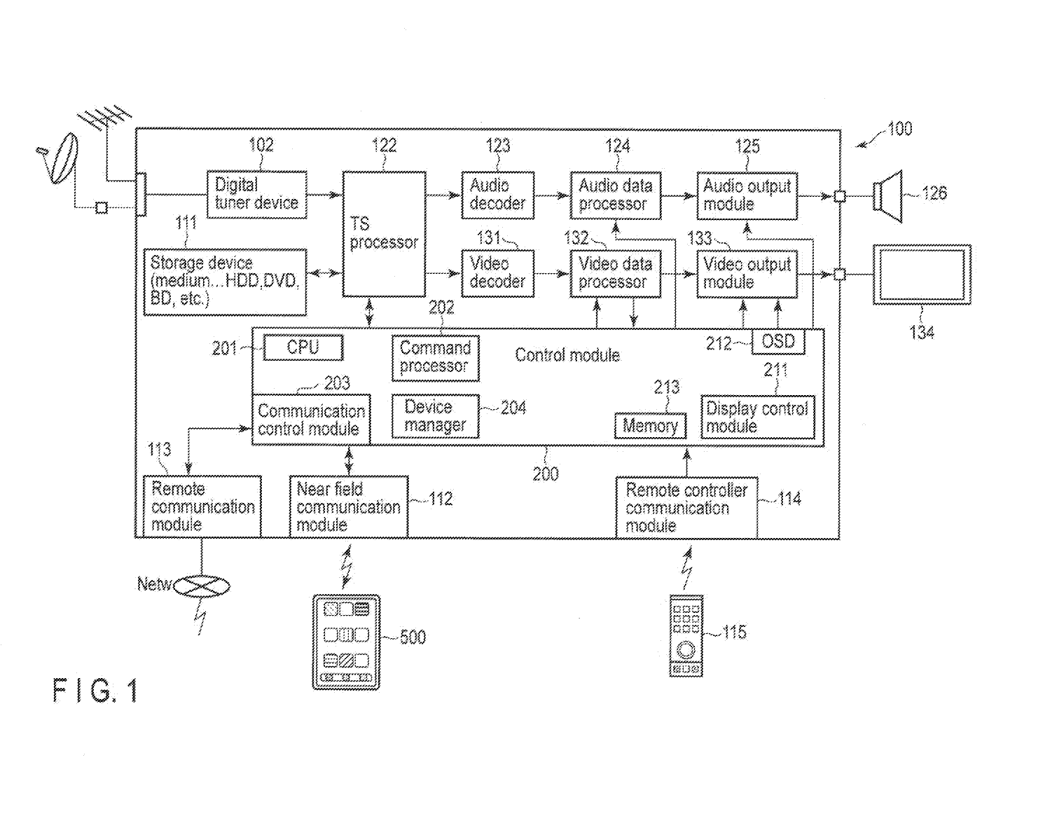

FIG. 1 is a block diagram showing a configuration example of an electronic device 100 (a television receiver or a personal computer) to which a present embodiment is applied. A digital tuner device 102 includes, for example, a plurality of tuners which receive scrambled digital terrestrial broadcasting signals. The digital tuner device 102 may include, for example, tuners for receiving satellite (BS/CS) digital broadcasting (not shown). For example, the digital tuner device 102 includes eight tuners. Each of the tuners can process different broadcast signals in parallel.

The tuners included in the digital tuner device 102 input transport streams (TS) of a plurality of acquired channels, respectively, to a TS processor 122. Each TS includes a packet sequence of a broadcast program of each channel. Each packet includes packet identification information and digital contents of the program. Some packets include control information, etc.

The TS processor 122 multiplexes TSs such that TSs of the plurality of channels become a single TS. The multiplexed TS includes a packet sequence of a broadcast program of each channel. Identification information for identifying a channel and a packet is added to a packet of each channel.

The multiplexed TS can be input to and stored in a storage device 111. A packet including control information in TSs input to the TS processor 122 is input to the control module 200 and processed.

The storage device 111 includes, for example, a hard disk drive and an optical disk recording and reproducing device. The optical disks include a Digital Versatile Disk (DVD) (registered trademark), a Blu-ray Disc (BD) (registered trademark), etc.

Control information included in the packets transmitted from the TS processor 122 to the control module 200 is, for example, information such as an entitlement control message (ECM) which is encrypted information on the broadcast program and an event information table (EIT) which is a table indicating event information such as program name, performers, start time and the like, and electronic program guide (EPG) information.

Video data included in a packet is encoded in, for example, the Moving Picture Experts Group (MPEG) format or the Advanced Video Coding (AVC) format. Audio data in an audio packet is encoded in, for example, pulse code modulation (PCM) format, Dolby format or MPEG format.

The TS processor 122 can select a TS from the storage device 111 or the digital tuner device 102 and perform a reproducing operation, based on the control signal from the control module 200. In other words, the TS processor 122 can separate audio packets including audio data of the program to be reproduced and video packets including the video data of the program to be reproduced from each other, based on the control signal of the control module 200.

An audio packet separated from the packet sequence in the TS processor 122 and including the audio data is input to an audio decoder 123 and decoded in accordance with the encoding format. The audio data decoded in the audio decoder 123 is subjected to synchronous processing, volume adjustment, etc., in an audio data processor 124 and supplied to an audio output module 125. The audio output module 125 performs stereo separation processing, etc., according to an electronic speaker device and supplies an output to a speaker 126.

A video packet separated from the packet sequence in the TS processor 122 and including the video data is input to a video decoder 131 and decoded in accordance with the encoding format. The video data decoded in the video decoder 131 is subjected to synchronous processing, brightness adjustment, color adjustment, color gamut determination, etc., in a video data processor 132. An output of the video data processor 132 is supplied to a video output module 133.

The video output module 133 can multiplex, for example, data, figures and a program guide from the control module 200 to a main image signal. In addition, the video output module 133 sets the scale, resolution, number of lines, aspect ratio, etc., according to a display device 134 to the output video signal and outputs them to the display device 134. The display device 134 is a video display device compatible with a wide color gamut. The display device 134 is a display capable of entirely displaying, for example, the BT.2020 color gamut.

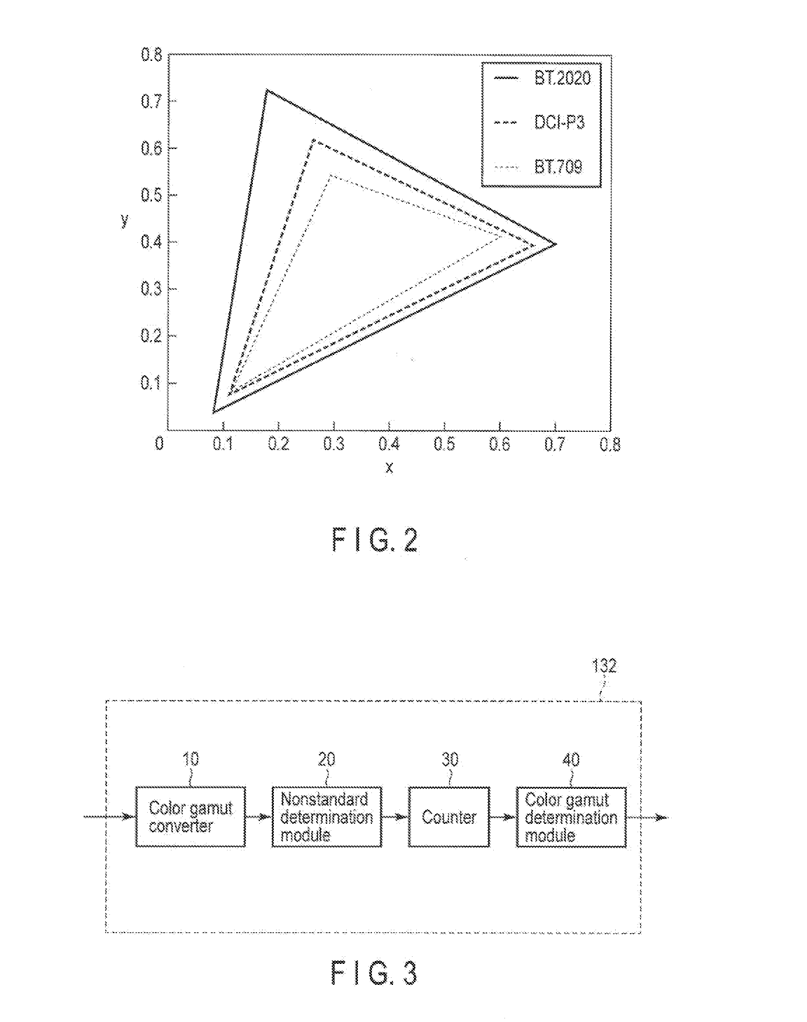

FIG. 2 is a graph showing the width of a color gamut of each of BT.2020, DCI-P3 and BT.709 by CIE xy chromaticity. The interior region of a triangle made of solid lines or broken lines is a color gamut of each of BT.2020, DCI-P3 and BT.709. Each color gamut shown in FIG. 2 is a conceptually-illustrated width of a color gamut of each of the signal standards. The width or the positional relationship between coordinates is not necessarily accurately illustrated in FIG. 2.

Audio packets and video packets of a pay program are often encrypted. In this case, a processing system for decryption using key information is also provided, but is omitted in the present embodiment.

The control module 200 comprises a central processing unit (CPU) 201, a command processor 202, a communication control module 203, a device manager 204, a display control module 211, an on-screen display (OSD) block 212, a memory 213, etc.

The control module 200 comprises an EPG data processor which generates a program guide signal prepared by using EPG data, a recording and reproducing control module for recording the signal in the storage device 111 or reproducing the signal from the storage device 111, etc. (not shown in FIG. 1).

The CPU 201 adjusts an operation sequence of the entire control module 200. The command processor 202 can analyze an operation command externally input and reflect an operation corresponding to the command on the television receiver 100. The device manager 204 stores device identification data of a mobile device 500, the remote controller 115, etc., which provide the control module 200 with an operation signal.

The display control module 211 can supply the program guide signal and a menu video signal to the video output module 133 via the OSD block 212. The display control module 211 can also execute adjustment processing of resolution, display size, display area, etc., of an image signal.

The memory 213 can retain various types of data and applications to be retained in the control module 200.

The communication control module 203 can communicate externally and import an operation command, data, content, etc. The imported content and data can be stored in, for example, the storage device 111 or the memory 212. The communication control module 203 can externally transmit data, content, etc., from the electronic device 100.

The communication control module 203 is connected to a receiving module (a near-field communication module 112 and a remote communication module 113). The near-field communication module 112 can transmit data to and receive data from the mobile device 500, and is for near-field communication. The operation of the electronic device 100 can be controlled by inputting an instruction to an instruction input module of the mobile device 500.

The remote communication module 113 can transmit data to and receive data from a remote server, a home server or a cloud server via the Internet. The remote communication module 113 communicates with the remote server, etc., wirelessly or by cable (optical cable, local area network). The remote server comprises a receiving module 340 which receives a command signal transmitted from the remote communication module.

The electronic device 100 can also receive the operation signal from the remote controller 115 via a receiving module (a remote controller communication module 114). Similarly to the mobile device 500, an instruction input module is provided in the remote controller 115.

The mobile device 500 can access a server via a base station (not shown), the Internet, etc. Not only content provided by the server, but also various types of applications and game software can be downloaded and transferred to the control module 200 via the near-field communication module 112.

The mobile device 500 can transfer information (for example, an address of a web server, a mail address, a network address, etc.) for acquiring content and various types of provided information to the control module 200 via the near-field communication module 122. The mobile device 500 may transfer, for example, the address of a web server, a mail address, a network address, etc., to the control module 200 via a base station and a network (Netw).

The communication control module 203 can acquire, for example, information related to the program via the remote communication module 113 by using the address of the web server, the mail address, etc.

When content, an application or game software is transferred from the mobile device 500, the communication control module 203 provided in the control module 203 is activated.

The communication control module 203 stores the received content in the memory 213. The content may be stored in the storage device 111 in accordance with an operation command or automatically. The storage device 111 can record the received content in, for example, a hard disk. In the hard disk, the content is managed as a content file.

The menu video signal, the program guide signal, etc., for display are controlled by the display control module 211. When a menu and a program guide are displayed, menu screen data and the program guide signal are read from the OSD block 212 under the control of the display control module 211 and supplied to the video output module 133. A menu image and a program guide image are thereby displayed on the display 134. The menu screen data and the program guide signal may be read from a data storage module (the memory or the hard disk) under the control of the display control module 211.

The menu video signal, the program guide signal, etc., for display may be transmitted to the mobile device 500. When the mobile device 500 requests the menu video signal, the program guide signal, etc., the display control module 211 can transmit the menu video signal and the program guide video signal to the mobile device 500.

The mobile device 500 can display the menu video signal and the program guide image signal on a touch panel screen. The user can provide the electronic device with an operation command signal by touching an operation button displayed on the touch (or point) panel screen.

The above is the brief description of the configuration of the electronic device 100 of the present embodiment. The video data processor 132 is hereinafter further described. FIG. 3 is a block diagram showing a configuration in the video data processor 132 along a flow of signal processing. In the electronic device 100 of the first embodiment, the video data processor 132 comprises a color gamut converter 10, a nonstandard determination module 20, a counter 30 and a color gamut determination module 40.

As described above, the video data decoded in the video decoder 131 is input to the video data processor 132. The color gamut converter 10 comprised in the video data processor 132 executes inverse gamma conversion for pixel data included in the video data input in the BT.2020 format, and then executes XYZ conversion. The color gamut converter 10 further converts the pixel data expressed by the XYZ colorimetric system into, for example, pixel data expressed by an RGB colorimetric system of BT.709. Next, the color gamut converter 10 standardizes the pixel data. As shown in FIG. 2, the BT.709 color gamut is narrower than the DCI-P3 color gamut and the BT.2020 color gamut. Therefore, when an RGB value is standardized, the value is within a range of 0 to 1 if the pixel data indicates a color within the BT.709 color gamut, and the value is less than 0 or greater than 1 if the pixel data indicates a color of the wider color gamut such as DCI-P3 and BT.2020. Based on this, it can be determined whether the color indicated by the pixel data input in the BT.2020 format is within a color gamut or not.

The above-described coordinate conversion executed by the color gamut converter 10 is a calculation using linear conversion. However, a publicly known method such as conversion using an LUT stored in the memory 213 and conversion using an approximate formula may be also used for the coordinate conversion.

The nonstandard determination module 20 determines whether the pixel data converted by the color gamut converter 10 is outside a predetermined color gamut (or within a predetermined color gamut). As described above, the BT.709 color gamut is narrower than the DCI-P3 color gamut and the BT.2020 color gamut. Therefore, when the RGB value is standardized, the value is within a range of 0 to 1 if the pixel data indicates a color within the BT.709 color gamut, and the value is less than 0 or greater than 1 if the pixel data indicates a color of the color gamut wider than BT.709 such as DCI-P3 and BT.2020. The nonstandard determination module 20 determines whether the pixel data has a value less than 0 or greater than 1, or a value within a range of 0 to 1. The above-described publicly known method can be used to determine whether the pixel data is within the predetermined color gamut.

The counter 30 counts the number of pixels of which chromaticity coordinate converted by the color gamut converter 10 is not in the predetermined color gamut.

The color gamut determination module 40 determines the color gamut of the input video data per frame based on the number of pixels counted by the counter 30, and finally determines the color gamut of the input video data based on the results of determinations of the predetermined number of frames.

More specifically, the color gamut determination module 40 determines that the color gamut of a frame is wider than the predetermined color gamut, for example, when the counted number of pixels, of the number of pixels of the frame, is greater than a predetermined value, or when the ratio of the counted number of pixels to the number of pixels of the frame is greater than a predetermined value. Then, the acquired result of determination per frame is stored, for example, in the memory 213. The color gamut of the input video data is finally determined based on the results of determinations of a plurality of frames.

The above-described method of determination is used when the nonstandard determination module 20 counts the number of nonstandard pixels. When the nonstandard determination module 20 counts the number of pixels within the standard, the color gamut determination module 40 determines that the color gamut of a frame is wider than the predetermined color gamut, for example, when the counted number of pixels, of the number of pixels of the frame, is less than a predetermined value, or when the ratio of the counted number of pixels to the number of pixels of the frame is less than a predetermined value.

The color gamut determination module 40 may execute color gamut determination for a plurality of frames instead of determining a color gamut per frame, and determine the color gamut of the input video data based on the color gamut determinations of the plurality of frames.

In the first embodiment, for example, when the predetermined color gamut is the BT.709 color gamut, the color gamut determination module 40 determines whether the color gamut of the input video signal is the color gamut of BT.709, BT.2020 or DCI-P3. In other words, in the first embodiment, when the color gamut determination module 40 determines that the color gamut of the input video signal is wider than the BT.709 color gamut, the color gamut of the input video signal may be determined as the color gamut of BT.2020 or DCI-P3.

For example, when the predetermined color gamut is the DCI-P3 color gamut, the color gamut determination module 40 determines whether the color gamut of the input video signal is the color gamut of DCI-P3 or BT.2020. In other words, in the first embodiment, when the color gamut determination module 40 determines that the color gamut of the input video signal is wider than the DCI-P3 color gamut, the color gamut of the input video signal may be determined as the BT.2020 color gamut.

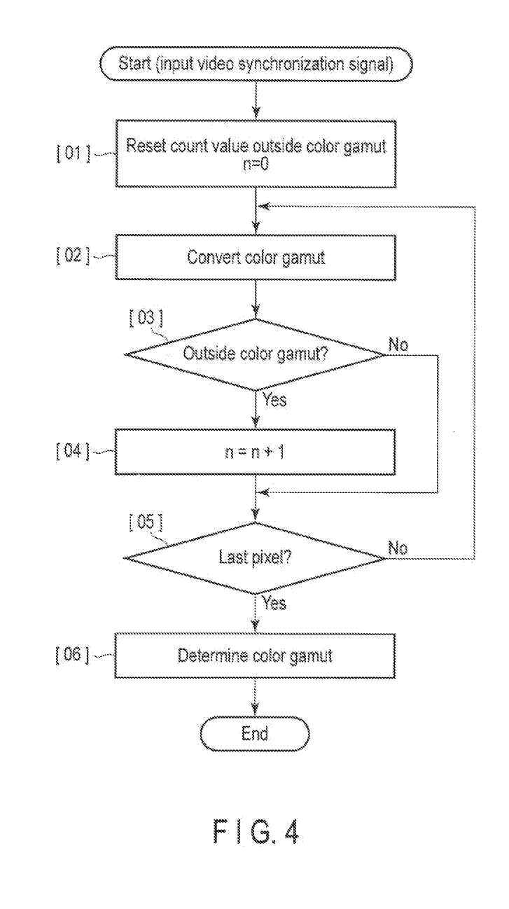

The color gamut determination processing of the video data processor 132 is further described with reference to a flowchart of the color gamut determination processing shown in FIG. 4.

First, a video synchronization signal is input with the video data, and the counter 30 is reset as an initial movement (step [01]). Next, in the color gamut converter 10, the color gamut determination processing is started from the first pixel of a frame based on the video synchronization signal, a colorimetric system of pixel data in the video data input per frame is converted, and the converted pixel data (pixel data expressed by RGB) is transmitted to the nonstandard determination module 20 (step [02]).

Next, in the nonstandard determination module 20, it is determined whether the transmitted pixel data is within the predetermined color gamut or not (step [03]). If the pixel data is outside the predetermined color gamut (Yes), a count value of the counter 30 is increased by one (step [04]). If the pixel data is not outside the predetermined color gamut (No), the count value of the counter 30 is not changed.

Next, in the color gamut determination module 40, it is determined whether the pixel data is the last pixel to be subjected to the determination processing or not (step [05]). If the pixel data is the last pixel (Yes), the count value of the number of pixels outside the color gamut is transmitted to the color gamut determination module 40, and the color gamut determination module 40 determines the color gamut of a frame (step [06]). If the pixel data is not the last pixel to be subjected to the determination processing (No), the same processing is repeated for the following pixel data. The above is the flow of the signal processing of the video data processor 132.

The electronic device 100 to which the above configuration is applied can determine the color gamut of the input video data. As a result, the electronic device 100 can execute suitable image processing based on the result of the color gamut determination for the input video data, and thereby allow the output video to be displayed vividly.

### Second Embodiment

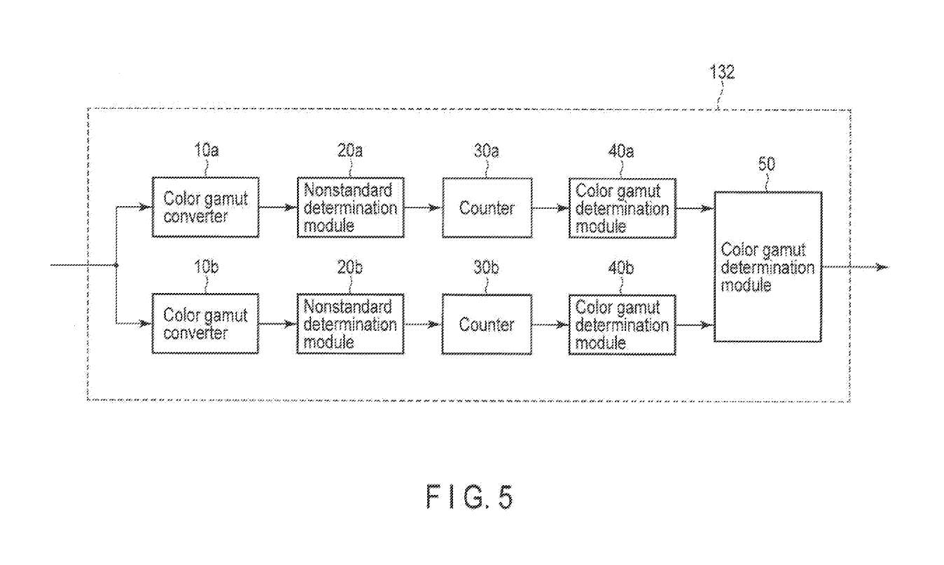

FIG. 5 is a block diagram showing a configuration in a video data processor 132 of a second embodiment along a flow of signal processing. In an electronic device 100 of the second embodiment, the video data processor 132 comprises a color gamut converter 10a, a nonstandard determination module 20a, a counter 30a, a color gamut determination module 40a, a color gamut converter 10b, a nonstandard determination module 20b, a counter 30b, a color gamut determination module 40b, a color gamut determination module 50 which finally determines a color gamut of input video data based on a result of initial determination of each of the color gamut determination module 40a and the color gamut determination module 40b.

The electronic device 100 of the second embodiment executes initial determination regarding two types of color gamuts for input pixel data, and executes final determination of the color gamut of the input video data based on two results of the initial determination.

The method of determining the color gamut is the same as the first embodiment. For example, the video data processor 132 executes initial determination (determination A) whether the color gamut of the input video data is the BT.709 color gamut or not (outside the BT.709 color gamut) by means of the color gamut converter 10a, the nonstandard determination module 20a, the counter 30a and the color gamut determination module 40a, and executes initial determination (determination B) whether the color gamut of the input video data is the DCI-P3 color gamut or not (outside the DCI-P3 color gamut) by means of the color gamut converter 10b, the nonstandard determination module 20b, the counter 30b and the color gamut determination module 40b.

When the result of determination A is the BT.709 color gamut, the color gamut determination module 50 determines that the color gamut of the input video data is the BT.709 color gamut regardless of the result of determination B. When the result of determination A is outside the BT.709 color gamut and the result of determination B is the DCI-P3 color gamut, the color gamut determination module 50 determines that the color gamut of the input video data is the DCI-P3 color gamut. When the result of determination A is outside the BT.709 color gamut and the result of determination B is outside the DCI-P3 color gamut, the color gamut determination module 50 determines that the color gamut of the input video data is the BT.2020 color gamut.

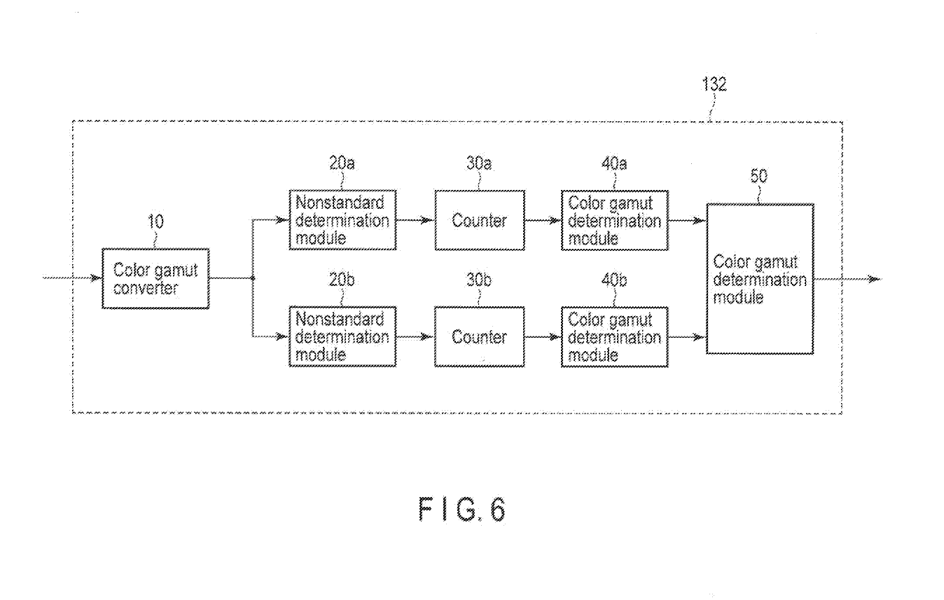

The input video data does not need to be separated before input to the color gamut converter 10, but may be separated and input to the nonstandard determination modules 20a and 20b after color coordinates of each pixel are converted into color coordinates of a predetermined colorimetric system by the color gamut converter 10 as shown in FIG. 6.

The electronic device 100 which adopts the above configuration can determine which of three different color gamuts the color gamut of the input video data is. As a result, the electronic device 100 can execute suitable image processing based on the result of the color determination for the input video data, and thereby allow the output video to be vividly displayed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a first color gamut converter configured to convert each pixel of input video data into RGB data;
a first nonstandard determination module configured to determine whether the RGB data converted by the first color gamut converter is outside a first color gamut or not;
a first counter configured to count number of pixels of which RGB data converted by the first color gamut converter is outside the first color gamut per unit time of the video data; and
a first color gamut determination module configured to determine, based on the number of pixels counted by the first counter, whether a color gamut of the input video data is the first color gamut or a color gamut wider than the first color gamut.

2. The device of claim 1, wherein
the first counter outputs a count value per frame in synchronization with frames of the input video data, and
the first color gamut determination module executes determination processing of the color gamut based on the count value per frame from the first counter.

3. The device of claim 1, further comprising:
a second color gamut converter configured to convert each pixel of the input video data into RGB data;
a second nonstandard determination module configured to determine whether the RGB data converted by the second color gamut converter is outside a second color gamut wider than the first color gamut or not;
a second counter configured to count number of pixels of which RGB data converted by the second color gamut converter is outside the second color gamut;
a second color gamut determination module configured to determine, based on the number of pixels counted by the second counter, whether the color gamut of the input video data is the second color gamut or a color gamut wider than the second color gamut; and
a third color gamut determination module configured to finally determine, based on the determination of the first color gamut determination module and the second color gamut determination module, which of the first color gamut, the second color gamut and a third color gamut wider than the second color gamut the color gamut of the input video data is.

4. The device of claim 1, further comprising:
a second nonstandard determination module configured to determine whether the RGB data converted by the first color gamut converter is outside a second color gamut wider than the first color gamut or not;
a second counter configured to count number of pixels of which RGB data converted by the first color gamut converter is outside the second color gamut;
a second color gamut determination module configured to determine, based on the number of pixels counted by the second counter, whether the color gamut of the input video data is the second color gamut or a color gamut wider than the second color gamut; and
a third color gamut determination module configured to finally determine, based on the determination of the first color gamut determination module and the second color gamut determination module, which of the first color gamut, the second color gamut and a third color gamut wider than the second color gamut the color gamut of the input video data is.

5. The device of claim 3, wherein
each of the first counter and the second counter outputs a count value per frame in synchronization with frames of the input video data,
the first color gamut determination module executes determination processing of the color gamut based on the count value per frame from the first counter, and
the second color gamut determination module executes determination processing of the color gamut based on the count value per frame from the second counter.

6. The device of claim 4, wherein
each of the first counter and the second counter outputs a count value per frame in synchronization with frames of the input video data,
the first color gamut determination module executes determination processing of the color gamut based on the count value per frame from the first counter, and
the second color gamut determination module executes determination processing of the color gamut based on the count value per frame from the second counter.

7. A color gamut determination method comprising:
converting each pixel of input video data into RGB data;
determining whether the converted RGB data is outside a first color gamut or not;
counting number of pixels of which converted RGB data is outside the first color gamut per unit time of the video data; and
determining, based on the counted number of pixels, whether a color gamut of the input video data is the first color gamut or a color gamut wider than the first color gamut.

8. The method of claim 7, further comprising:
outputting a count value per frame in synchronization with frames of the input video data; and
executing determination processing of the color gamut based on the count value per frame.

9. The method of claim 7, further comprising:
converting each pixel of the input video data into RGB data in a different manner from the converting;
determining whether the RGB data converted in the different manner is outside a second color gamut wider than the first color gamut or not;
counting number of pixels of which converted RGB data is outside the second color gamut;
determining, based on the counted number of pixels, whether the color gamut of the input video data is the second color gamut or a color gamut wider than the second color gamut; and
finally determining, based on the two determinations, which of the first color gamut, the second color gamut and a third color gamut wider than the second color gamut the color gamut of the input video data is.

10. The method of claim 7, further comprising:
determining whether the converted RGB data is outside a second color gamut wider than the first color gamut or not;
counting number of pixels of which converted RGB data is outside the second color gamut;
determining, based on the counted number of pixels outside the second color gamut, whether the color gamut of the input video data is the second color gamut or a color gamut wider than the second color gamut; and
finally determining, based on the two determinations, which of the first color gamut, the second color gamut and a third color gamut wider than the second color gamut the color gamut of the input video data is.

11. The method of claim 9, the counting the number of pixels outside the first color gamut and the number of pixels outside the second color gamut comprising:
outputting a count value per frame in synchronization with frames of the input video data; and
executing determination processing of the first color gamut and the second color gamut based on the count value per frame.

11. The method of claim 10, the counting the number of pixels outside the first color gamut and the number of pixels outside the second color gamut comprising:
outputting a count value per frame in synchronization with frames of the input video data; and
executing determination processing of the first color gamut and the second color gamut based on the count value per frame.
